(19) United States
(12) Patent Application Publication
(10) Pub. No.: US 2022/0407253 A1
(43) Pub. Date: Dec. 22, 2022

(54) CONNECTOR, ELECTRONIC CONTROL UNIT, TERMINAL PART, AND PAIR OF END PARTS

(71) Applicant: YAZAKI CORPORATION, Tokyo (JP)

(72) Inventor: Jun GOTO, Makinohara-shi (JP)

(21) Appl. No.: 17/744,626

(22) Filed: May 14, 2022

(30) Foreign Application Priority Data
May 14, 2021 (JP) 2021-082622

(51) Int. Cl. H01R 12/72; H01R 12/70

(52) U.S. Cl. CPC H01R 12/721; H01R 12/7023

(57) ABSTRACT

A connector includes: a terminal part including a terminal fitting and a housing; and a first end part and a second end part configured to be arranged on the substrate in an arrangement direction. The terminal part includes a first locking portion provided in the housing and configured to be locked to adjacent parts on both sides in the arrangement direction. Each of the first end part and the second end part includes: a fixing portion configured to be fixed to the substrate; and a second locking portion configured to be locked to the first locking portion of an adjacent terminal part in the arrangement direction. The first end part, the terminal part, and the second end part are connected while being arranged in this order on the substrate.

### CROSS-REFERENCE TO RELATED APPLICATIONS

This application is based on and claims the benefit of priority of Japanese Patent Application No. 2021-082622 filed on May 14, 2021, the entire contents of which are incorporated herein by reference.

### FIELD

The present disclosure relates to a connector, an electronic control unit, a terminal part, and a pair of end parts.

### BACKGROUND

A connector for connection to an external device or the like may be mounted on a substrate. As such a connector mounted on the substrate, for example, a connector described in JP-A-2015-041510 has been proposed. JP-A-2015-041510 discloses that connectors are mounted side by side, and the number of connectors is equal to the number of counterpart connectors to be connected to a substrate.

However, each connector in JP-A-2015-041510 is provided with receiving portions on both sides in a width direction, and the receiving portions of the adjacent connectors are overlapped with each other, and are fixed to the substrate by passing a fixing fitting through both receiving portions. Therefore, when a plurality of connectors are mounted on the substrate, there is a problem that a size increases in the width direction.

### SUMMARY

The present disclosure has been made in view of the above circumstances, and an object of the present disclosure is to provide a connector, an electronic control unit, a terminal part, and a pair of end parts that are reduced in size while easily coping with variations of a counterpart connector.

The present disclosure provides a connector mountable on a substrate and configured to be fitted to a counterpart connector, the connector including: at least one terminal part, each of the at least one terminal part including: a terminal fitting configured to be connected to the substrate; and a housing that holds the terminal fitting so as to allow the terminal fitting to be fitted to the counterpart connector in a fitting direction; and a pair of end parts including a first end part and a second end part, the first end part and the second end part being configured to be arranged on the substrate in an arrangement direction perpendicular to the fitting direction such that the at least one terminal part is positioned between the first end part and the second end part, wherein each of the at least one terminal part includes a first locking portion provided in the housing and configured to be locked to adjacent parts on both sides in the arrangement direction, wherein each of the first end part and the second end part includes: a fixing portion configured to be fixed to the substrate; and a second locking portion configured to be locked to the first locking portion of an adjacent terminal part in the arrangement direction among the at least one terminal part, and wherein the first end part, the at least one terminal part, and the second end part are connected while being arranged in this order on the substrate.

The present disclosure provides an electronic control unit including: a substrate; an electronic part mounted on the substrate; the above-described connector, which is mounted on the substrate; and a case that accommodates the substrate, wherein a fitting surface of the connector with respect to a counterpart connector is exposed from an opening provided in the case.

The present disclosure provides a terminal part including: a terminal fitting configured to be connected to a substrate; a housing that holds the terminal fitting so as to allow the terminal fitting to be fitted to a counterpart connector in a fitting direction; and a first locking portion provided in the housing and configured to be locked to adjacent parts on both sides in a direction perpendicular to the fitting direction.

The present disclosure provides a pair of end parts including: a first end part; and a second end part, wherein the first end part and the second end part are configured to be arranged on a substrate such that at least one terminal part is positioned between the first end part and the second end part, each of the at least one terminal part including a terminal fitting configured to be connected to the substrate and a housing holding the terminal fitting, and wherein each of the first end part and the second end part includes: a fixing portion configured to be fixed to the substrate; and a second locking portion configured to be locked to an adjacent terminal part among the at least one terminal part.

The present disclosure has been briefly described above. Details of the present disclosure will be further clarified by reading an aspect (hereinafter, referred to as an “embodiment”) for implementing the invention to be described below with reference to the accompanying drawings.

### BRIEF DESCRIPTION OF DRAWINGS

FIG. 1 is an exploded perspective view showing an electronic control unit according to an embodiment of the present disclosure;

FIG. 2 is a front view of a connector constituting the electronic control unit shown in FIG. 1;

FIG. 3 is an exploded front view of the connector shown in FIG. 2;

FIG. 4A to FIG. 4D are a front view, a left side view, a right side view, and a top view of a terminal part constituting the connector shown in FIG. 2, respectively;

FIG. 5A to FIG. 5D are a front view, a left side view, a right side view, and a top view of a left end part constituting the connector shown in FIG. 2, respectively;

FIG. 6A to FIG. 6D are a front view, a left side view, a right side view, and a top view of a right end part constituting the connector shown in FIG. 2, respectively;

FIG. 7 is a front view of a connector according to another embodiment;

FIG. 8 is a front view of a connector according to yet another embodiment;

FIG. 9 is a front view of a connector according to still another embodiment; and

FIG. 10 is an exploded front view of the connector shown in FIG. 9.

### DETAILED DESCRIPTION

Specific embodiments according to the present disclosure will be described below with reference to the accompanying drawings.

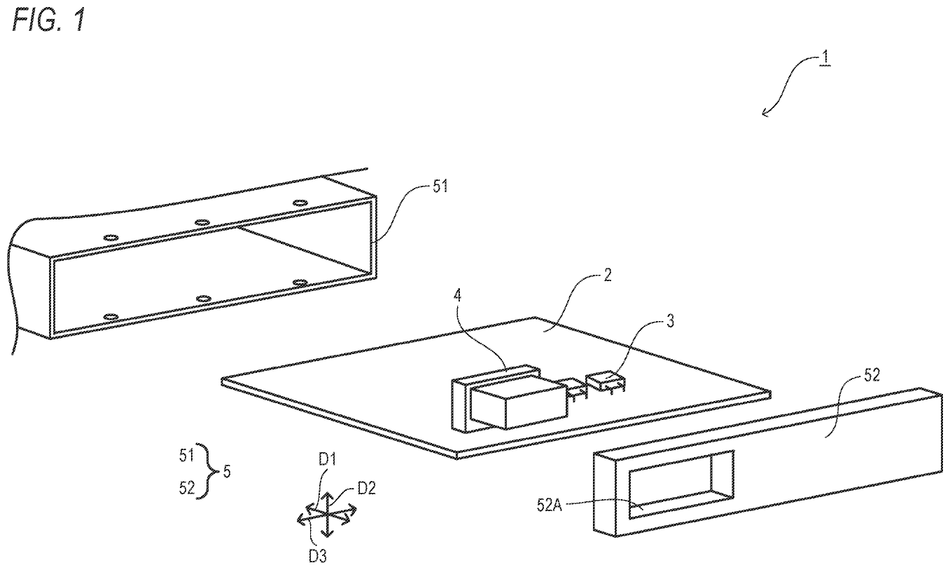

As shown in FIG. 1, an electronic control unit 1 according to an embodiment includes a substrate 2, electronic parts 3 mounted on the substrate 2, a connector 4 mounted on the substrate 2, and a case 5 that accommodates the substrate.

The substrate 2 is provided in a flat plate shape, and the electronic parts 3 and the connector 4 are mounted on an upper surface thereof. The electronic parts 3, and terminal fittings 9 to be described later constituting the connector 4 are electrically connected to each other by a wiring pattern formed on the substrate 2 by printing or the like.

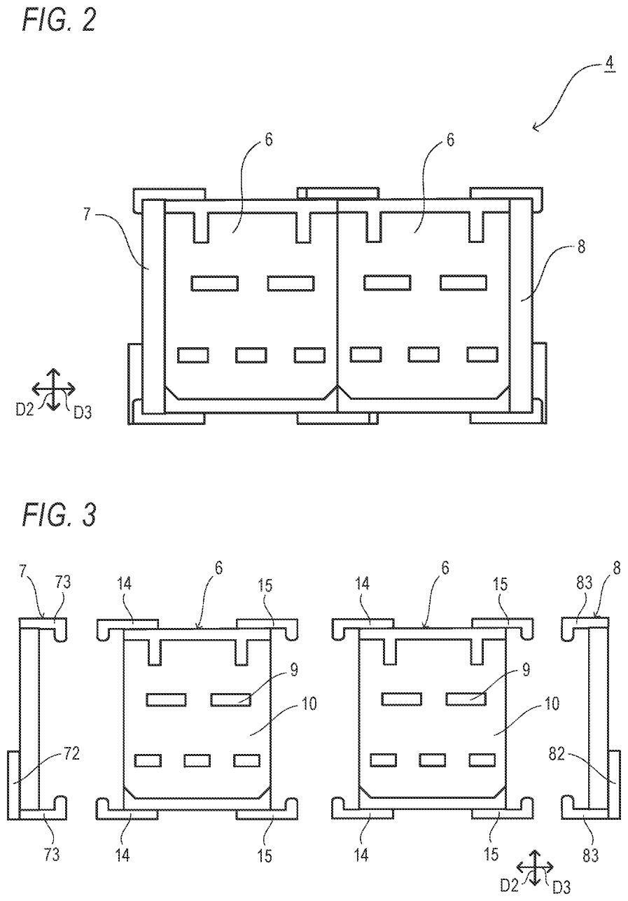

As shown in FIGS. 2 and 3, the connector 4 in the present embodiment includes two terminal parts 6, and a left end part 7 (an example of a first end part) and a right end part 8 (an example of a second end part) which are a pair of end parts. These parts 6 to 8 are arranged on the substrate 2 along an arrangement direction D3 perpendicular to a fitting direction D1 of the connector 4. More specifically, the left end part 7, the two terminal parts 6, and the right end part 8 are connected while being arranged in this order from a left side, which is one side in the arrangement direction D3, to a right side, which is the other side.

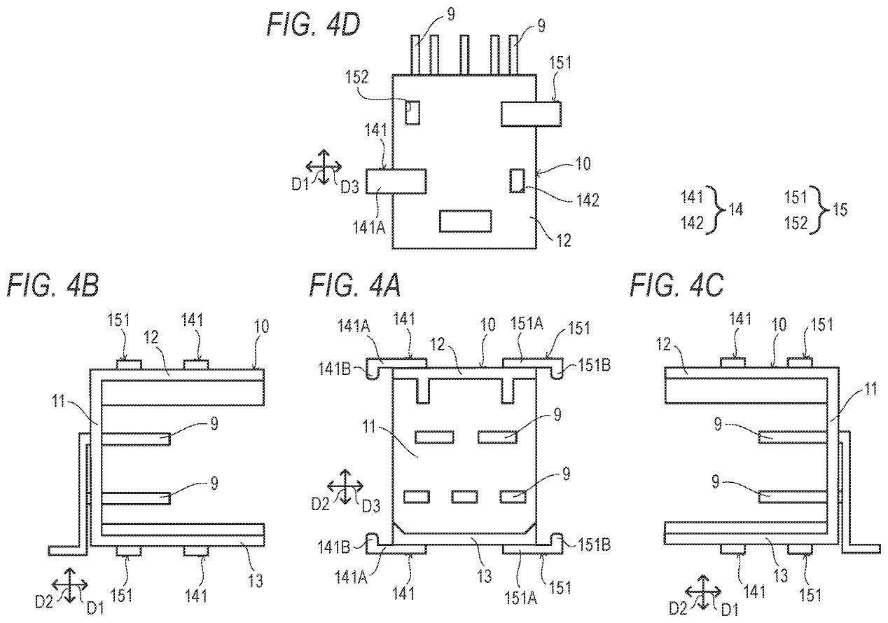

In the present embodiment, the two terminal parts 6 have the same size and the same shape as each other. As shown in FIG. 4, the terminal part 6 includes the terminal fittings 9 to be connected to the substrate 2, and a housing 10 holding the terminal fittings 9. The terminal fitting 9 is formed in a substantially L-shape, and one end thereof is accommodated in the housing 10, and the other end thereof protrudes outside the housing 10, and is connectable to the substrate 2. The one end of the terminal fitting 9 accommodated in the housing 10 is provided in a shape of a male terminal, and is capable of being fitted to a female terminal fitting of a female connector (not shown) as a counterpart connector.

The housing 10 is made of an insulating material such as a synthetic resin. The housing 10 includes support walls 11 that support the terminal fitting 9, an upper wall (a first cover wall) 12 that is continuous with the support walls 11 and covers a side of the terminal fitting 9 (an example of a first side of the terminal fitting 9) away from the substrate 2, and a lower wall (a second cover wall) 13 that is continuous with the support walls 11 and covers a substrate 2 side of the terminal fitting 9 (an example of a second side of the terminal fitting 9). The support walls 11 are provided perpendicular to the fitting direction D1 of the terminal fitting 9. Each support wall 11 is formed with insertion holes (not shown) into which the terminal fittings 9 are inserted, respectively.

The upper wall 12 is erected from an end portion of the support wall 11 on an upper side in an up-down direction D2 (the side away from the substrate 2) toward a female connector side in the fitting direction D1. The up-down direction D2 is a direction perpendicular to the substrate 2. The lower wall 13 is erected from an end portion of the support wall 11 on a lower side in the up-down direction D2 (the substrate 2 side) toward the female connector side in the fitting direction D1. The housing 10 is not provided with a side wall, and is opened on both sides in the arrangement direction D3.

The upper wall 12 and the lower wall 13 are each provided with locking pairs 14 and 15 as a first locking portion to be locked to the parts 6 to 8 arranged adjacent on both sides in the arrangement direction D3. The locking pair 14 includes a locking arm 141 and a locking hole 142. The locking arm 141 and the locking hole 142 are provided to be arranged in the arrangement direction D3. In the present embodiment, the locking arm 141 is disposed on a left side in the arrangement direction D3, and the locking hole 142 is disposed on a right side in the arrangement direction D3. The locking arm 141 includes an arm body 141A protruding from the upper wall 12 or the lower wall 13 toward the left side in the arrangement direction D3, and a locking projection 141B protruding from a tip of the arm body 141A.

The locking pairs 14 and 15 are arranged along the fitting direction D1. In the present embodiment, the locking pair 14 is disposed on the female connector side (the one side) in the fitting direction D1, and the locking pair 15 is disposed on the side (the other side) away from the female connector in the fitting direction D1. The locking pair 15 includes a locking arm 151 and a locking hole 152. The locking arm 151 and the locking hole 152 are provided to be arranged in the arrangement direction D3. In the present embodiment, the locking arm 151 is disposed on the left side in the arrangement direction D3, and the locking hole 152 is disposed on the right side in the arrangement direction D3. The locking arm 151 includes an arm body 151A protruding from the upper wall 12 or the lower wall 12 toward the right side in the arrangement direction D3, and a locking projection 151B protruding from a tip of the arm body 151A.

As shown in FIG. 2, when the two terminal parts 6 are arranged in the arrangement direction D3, the locking projection 141B provided on the locking arm 141 of the right terminal part 6 is fitted into the locking hole 142 of the left terminal part 6, and the two terminal parts 6 are locked. The locking projection 151B provided on the locking arm 151 of the left terminal part 6 is fitted into the locking hole 152 of the right terminal part 6, and the two terminal parts 6 are locked.

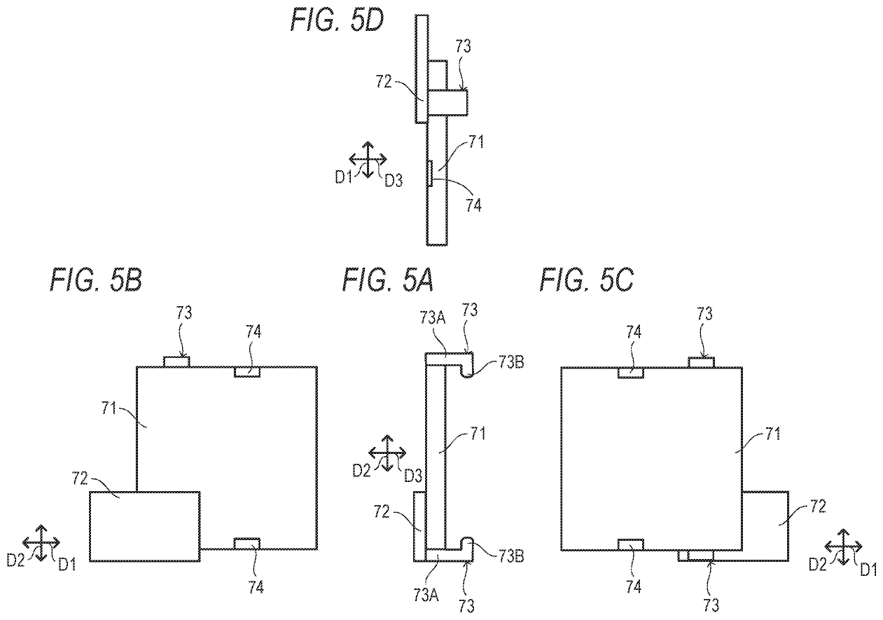

The left end part 7 and the right end part 8 are arranged on the substrate 2 in the arrangement direction D3. The two terminal parts 6 are positioned between the left end part 7 and the right end part 8. As shown in FIGS. 2 and 3, the left end part 7 is disposed on a left side of the two terminal parts 6 in the arrangement direction D3, and is locked to a leftmost side of the two terminal parts 6. As shown in FIG. 5, the left end part 7 includes a body wall 71 that closes an opening of the housing 10 of the terminal part 6 on the left side in the arrangement direction D3, a fixing portion 72 that is provided outside the body wall 71 and is to be fixed to the substrate 2, and locking arms 73 and locking holes 74 as a second locking portion to be locked to the locking pairs 14 and 15 of the adjacent terminal part 6 on the right side in the arrangement direction D3.

The body wall 71 is provided perpendicular to the arrangement direction D3. The fixing portion 72 includes a peg or a screw boss, and is to be fixed to the substrate 2. The locking arms 73 and the locking holes 74 are provided to be arranged along the fitting direction D1. In the present embodiment, the locking holes 74 are disposed on the female connector side in the fitting direction D1, and the locking arms 73 are disposed on the side away from the female connector in the fitting direction D1. The locking arm 73 includes an arm body 73A protruding from an upper surface or a lower surface of the body wall 71 toward the right side in the arrangement direction D3, and a locking projection 73B protruding from a tip of the arm body 73A. The locking holes 74 are provided on the upper surface and a left side surface of the body wall 71.

The locking projection 73B of the locking arm 73 is fitted into the locking hole 152 of the adjacent terminal part 6 on the right side in the arrangement direction D3. The locking projection 141B of the locking arm 141 of the adjacent terminal part 6 on the right side in the arrangement direction D3 is fitted into the locking hole 74. Accordingly, the terminal part 6 and the left end part 7 are locked to each other.

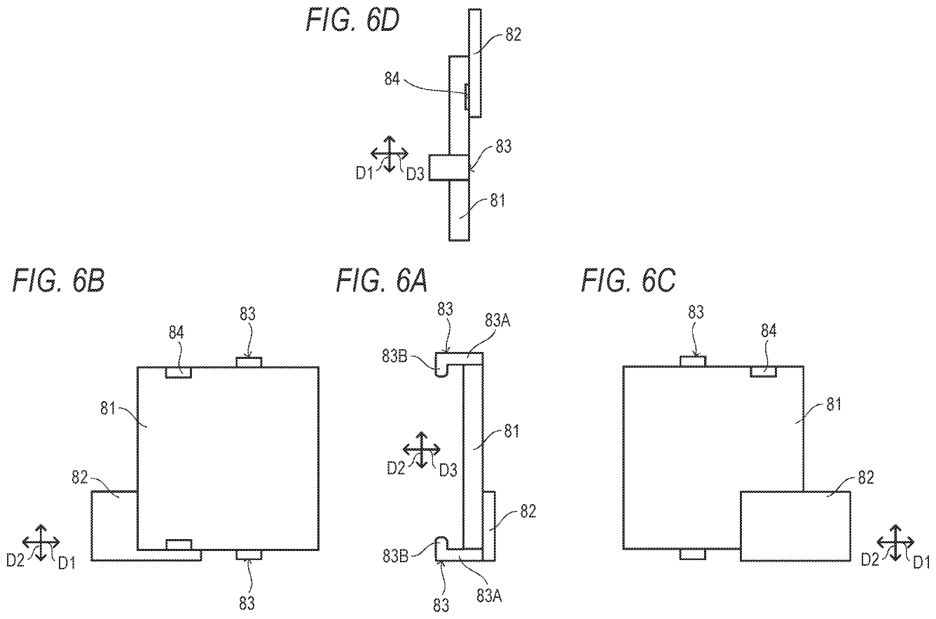

As shown in FIGS. 2 and 3, the right end part 8 is disposed on a right side of the two terminal parts 6 in the arrangement direction D3, and is locked to a rightmost side of the two terminal parts 6. As shown in FIG. 6, the right end part 8 includes a body wall 81 that closes an opening of the housing 10 of the terminal part 6 on the right side in the arrangement direction D3, a fixing portion 82 that is provided outside the body wall 81 and is to be fixed to the substrate 2, and locking arms 83 and locking holes 84 as a second locking portion to be locked to the locking pairs 14 and 15 of the adjacent terminal part 6 on the left side in the arrangement direction D3.

The body wall 81 is provided perpendicular to the arrangement direction D3. The fixing portion 82 includes a peg or a screw boss, and is to be fixed to the substrate 2. The locking arms 83 and the locking holes 84 are provided to be arranged along the fitting direction D1. In the present embodiment, the locking arms 83 are disposed on the female connector side in the fitting direction D1, and the locking holes 84 are disposed on the side away from the female connector in the fitting direction D1. The locking arm 83 includes an arm body 83A protruding from an upper surface or a lower surface of the body wall 81 toward the left side in the arrangement direction D3, and a locking projection 83B protruding from a tip of the arm body 83A. The locking holes 84 are provided on the upper surface and a right side surface of the body wall 81.

The locking projection 83B of the locking arm 83 is fitted into the locking hole 142 of the adjacent terminal part 6 on the left side in the arrangement direction D3. The locking projection 151B of the locking arm 151 of the adjacent terminal part 6 on the left side in the arrangement direction D3 is fitted into the locking hole 84. Accordingly, the terminal part 6 and the right end part 8 are locked to each other.

According to the above configuration, as shown in FIG. 2, the left end part 7, the two terminal parts 6, and the right end part 8 are connected while being arranged in this order and arranged on the substrate 2, and the fixing portion 72 of the left end part 7 and the fixing portion 82 of the right end part 8 are fixed to the substrate 2, so that the connector 4 can be fixed.

As shown in FIG. 1, the case 5 includes a case body 51 in which the female connector side in the fitting direction D1 is opened, and a front cover 52 that closes an opening of the case body 51. The front cover 52 is provided with an opening 52A, and the terminal fittings 9 of the connector 4, that is, a fitting surface is exposed from the opening 52A. When the female connector is inserted into the case 5 through the opening 52A, the female connector and the connector 4 are fitted and electrically connected.

According to the above embodiment, the fixing portions 72 and 82 to be fixed to the substrate 2 are provided on the left end part 7 and the right end part 8 alone that position the terminal part 6 therebetween, and the fixing portions 72 and 82 are not provided on the terminal part 6. Therefore, even when there are a plurality of terminal parts 6, a size can be reduced. In addition, according to the electronic control unit 1, the terminal part 6, and the left and right end parts 7 and 8 of the present embodiment, it is possible to easily cope with variations of the counterpart connector by changing the number and the shape of the terminal part 6.

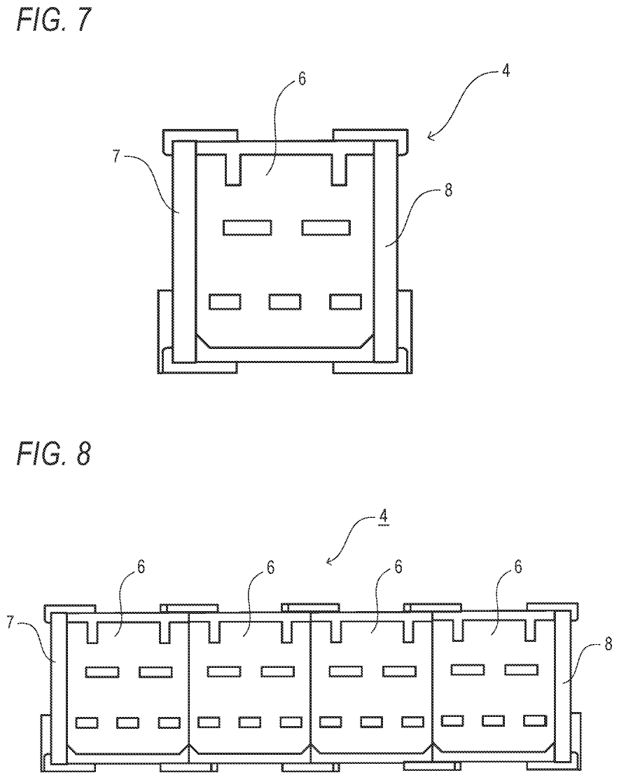

That is, according to the above embodiment, two terminal parts 6 are provided, but depending on the number of female connectors, one terminal part 6 may be positioned and locked between the left end part 7 and the right end part 8 as shown in FIG. 7.

The number of terminal parts 6 positioned between the left end part 7 and the right end part 8 may be three or more. An example shown in FIG. 8 is an example in which four terminal parts 6 are positioned.

According to the above embodiment, the housing 10 of the terminal part 6 is provided with the openings on both sides in the arrangement direction D3. Accordingly, a size of the connector 4 can be further reduced.

The present disclosure is not limited to the above embodiment, and modifications, improvements, and the like can be made as appropriate. In addition, materials, shapes, dimensions, numbers, arrangement positions, and the like of components in the above embodiment are freely set and are not limited as long as the present disclosure can be achieved.

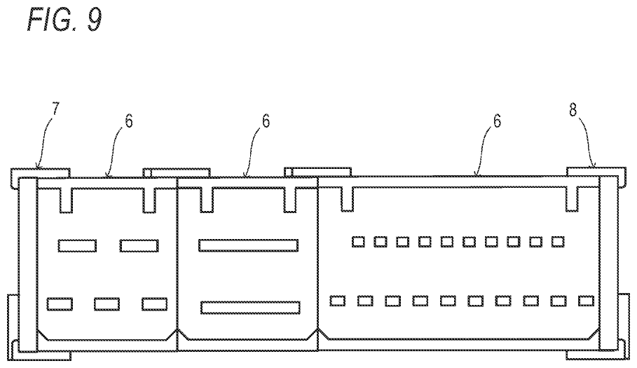

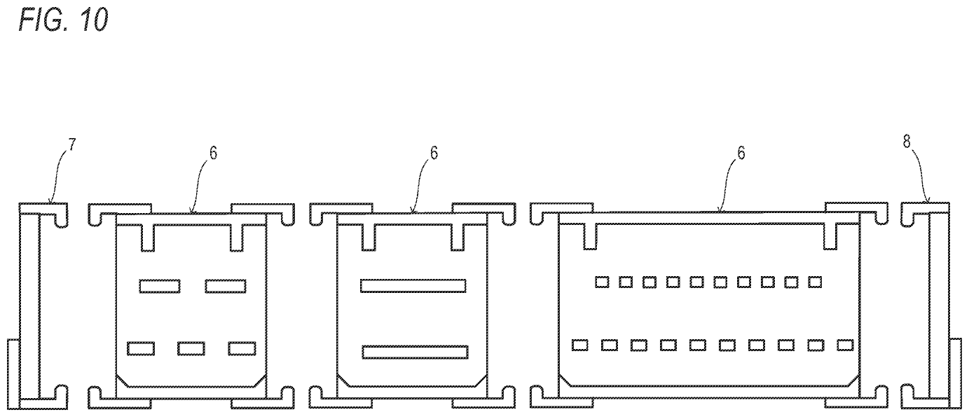

In the above embodiment, the terminal parts 6 have the same shape, but the present disclosure is not limited thereto. As shown in FIGS. 9 and 10, the terminal parts 6 may have different shapes in accordance with a shape of the female connector.

A connector 4 according to an embodiment of the present disclosure is a connector 4 mountable on a substrate 2 and configured to be fitted to a counterpart connector, the connector 4 including: at least one terminal part 6, each of the at least one terminal part 6 including a terminal fitting 9 configured to be connected to the substrate 2, and a housing 10 that holds the terminal fitting 9 so as to allow the terminal fitting 9 to be fitted to the counterpart connector in a fitting direction D1; and a pair of end parts 7 and 8 including a first end part 7 and a second end part 8, the first end part 7 and the second end part 8 being configured to be arranged on the substrate 2 in an arrangement direction D3 perpendicular to the fitting direction D1 such that the at least one terminal part 6 is positioned between the first end part 7 and the second end part 8, in which each of the at least one terminal part 6 further includes a first locking portion 14, 15 provided in the housing 10 and configured to be locked to adjacent parts 6, 7, 8 on both sides in the arrangement direction D3, each of the first end part 7 and the second end part 8 includes a fixing portion 72, 82 configured to be fixed to the substrate 2, and a second locking portion 73, 74, 83, 84 configured to be locked to the first locking portion 14, 15 of an adjacent terminal part 6 in the arrangement direction D3 among the at least one terminal part 6, and the first end part 7, the at least one terminal part 6, and the second end part 8 are connected while being arranged in this order on the substrate 2.

The at least one terminal part 6 includes a plurality of terminal parts 6 configured to be arranged on the substrate 2 in the arrangement direction D3, and the first locking portion 14, 15 of each of the plurality of terminal parts 6 is configured to be locked to the first locking portion 14, 15 of another adjacent terminal part 6 in the arrangement direction D3.

The housing 10 includes a support wall 11 that allows the terminal fitting 9 to penetrate therethrough to support the terminal fitting 9, a first cover wall 12 that is continuous with the support wall 11 and covers a first side of the terminal fitting 9 opposite to a second side facing the substrate 2, and a second cover wall 13 that is continuous with the support wall 11 and covers the second side of the terminal fitting 9, and both sides of the housing 10 in the arrangement direction D3 are opened.

An electronic control unit 1 according to an embodiment of the present disclosure includes a substrate 2, an electronic part 3 mounted on the substrate 2, the above-described connector 4 which is mounted on the substrate 2, and a case 5 that accommodates the substrate 2, and a fitting surface of the connector 4 with respect to a counterpart connector is exposed from an opening 52A provided in the case 5.

A terminal part 6 according to an embodiment of the present disclosure includes a terminal fitting 9 configured to be connected to a substrate 2, a housing 10 that holds the terminal fitting 9 so as to allow the terminal fitting 9 to be fitted to a counterpart connector in a fitting direction D1, and a first locking portion 14, 15 provided in the housing 10 and configured to be locked to adjacent parts on both sides in a direction D3 perpendicular to the fitting direction D1.

A pair of end parts 7 and 8 according to an embodiment of the present disclosure includes a first end part 7 and a second end part 8. The first end part 7 and the second end part 8 are configured to be arranged on a substrate 2 such that at least one terminal part 6 is positioned between the first end part 7 and the second end part 8, each of the at least one terminal part 6 including a terminal fitting 9 configured to be connected to the substrate 2 and a housing 10 holding the terminal fitting 9, and each of the first end part 7 and the second end part 8 includes a fixing portion 72, 82 configured to be fixed to the substrate 2, and a second locking portion 73, 74, 83, 84 configured to be locked to an adjacent terminal part 6 among the at least one terminal part 6.

According to the connector 4, the electronic control unit 1, the terminal part 6, and the pair of end parts 7 and 8, it is possible to easily cope with variations of the counterpart connector by changing the number and the shape of the terminal part 6 sandwiched between the pair of end parts 7 and 8. The fixing portions 72 and 82 to be fixed to the substrate 2 are provided on the pair of end parts 7 and 8 alone that position the terminal part 6 therebetween, and no fixing portions are provided on the terminal part 6. Therefore, even when there are a plurality of terminal parts 6, a size can be reduced.

The housing 10 is opened on both sides in the arrangement direction D3, and thus the size can be further reduced.

According to the present disclosure, it is possible to provide a connector, an electronic control unit, a terminal part, and a pair of end parts that are reduced in size while easily coping with variations of a counterpart connector.

1. A connector mountable on a substrate and configured to be fitted to a counterpart connector, the connector comprising:
at least one terminal part, each of the at least one terminal part comprising:
a terminal fitting configured to be connected to the substrate; and
a housing that holds the terminal fitting so as to allow the terminal fitting to be fitted to the counterpart connector in a fitting direction; and
a pair of end parts comprising a first end part and a second end part, the first end part and the second end part being configured to be arranged on the substrate in an arrangement direction perpendicular to the fitting direction such that the at least one terminal part is positioned between the first end part and the second end part,
wherein each of the at least one terminal part comprises a first locking portion provided in the housing and configured to be locked to adjacent parts on both sides in the arrangement direction,
wherein each of the first end part and the second end part comprises:
a fixing portion configured to be fixed to the substrate; and
a second locking portion configured to be locked to the first locking portion of an adjacent terminal part in the arrangement direction among the at least one terminal part, and
wherein the first end part, the at least one terminal part, and the second end part are connected while being arranged in this order on the substrate.

2. The connector according to claim 1,
wherein the at least one terminal part comprises a plurality of terminal parts configured to be arranged on the substrate in the arrangement direction, and
wherein the first locking portion of each of the plurality of terminal parts is configured to be locked to the first locking portion of another adjacent terminal part in the arrangement direction.

3. The connector according to claim 1,
wherein the housing comprises:
a support wall that allows the terminal fitting to penetrate therethrough to support the terminal fitting;
a first cover wall that is continuous with the support wall and covers a first side of the terminal fitting opposite to a second side facing the substrate; and
a second cover wall that is continuous with the support wall and covers the second side of the terminal fitting, and
wherein both sides of the housing in the arrangement direction are opened.

4. An electronic control unit comprising:
a substrate;
an electronic part mounted on the substrate;
the connector according to claim 1, which is mounted on the substrate; and
a case that accommodates the substrate,
wherein a fitting surface of the connector with respect to a counterpart connector is exposed from an opening provided in the case.

5. A terminal part comprising:
a terminal fitting configured to be connected to a substrate;
a housing that holds the terminal fitting so as to allow the terminal fitting to be fitted to a counterpart connector in a fitting direction; and
a first locking portion provided in the housing and configured to be locked to adjacent parts on both sides in a direction perpendicular to the fitting direction.

6. A pair of end parts comprising:
a first end part; and
a second end part,
wherein the first end part and the second end part are configured to be arranged on a substrate such that at least one terminal part is positioned between the first end part and the second end part, each of the at least one terminal part comprising a terminal fitting configured to be connected to the substrate and a housing holding the terminal fitting, and
wherein each of the first end part and the second end part comprises:
a fixing portion configured to be fixed to the substrate; and
a second locking portion configured to be locked to an adjacent terminal part among the at least one terminal part.
